(19) United States
(12) Patent Application Publication
(10) Pub. No.: US 2024/0161498 A1
(43) Pub. Date: May 16, 2024

(54) NON-CONTRASTIVE UNSUPERVISED LEARNING OF PHYSIOLOGICAL SIGNALS FROM VIDEO

(71) Applicants: Securiport LLC, Reston, VA (US); University of Notre Dame du Lac, South Bend, IN (US)

(72) Inventors: Jeremy Speth, South Bend, IN (US); Nathan Vance, South Bend, IN (US); Patrick Flynn, South Bend, IN (US); Adam Czajka, South Bend, IN (US)

(21) Appl. No.: 18/389,049

(22) Filed: Nov. 13, 2023

Related U.S. Application Data
(60) Provisional application No. 63/424,606, filed on Nov. 11, 2022.

(51) Int. Cl. G06V 20/40; G06V 10/80; G06V 10/82

(52) U.S. Cl. CPC G06V 20/41; G06V 10/809; G06V 10/82

(57) ABSTRACT

Systems, devices, methods, and non-transitory computer-readable instructions for non-contrastive unsupervised learning of a physiological signal from a video stream, the computer-implemented method including capturing the video stream of a subject, the video stream including a sequence of frames; processing each frame of the video stream to update a physiological signal detection function; determining the physiological signal from the video stream, and applying the updated physiological signal detection function to a subsequent video steam.

### PRIORITY INFORMATION

This application claims the benefit of U.S. Provisional Patent Application No. 63/424,606 filed on Nov. 11, 2022, which is hereby incorporated by reference in its entirety.

### FIELD OF THE INVENTION

The embodiments of the present invention generally relate to use of biometrics, and more particularly, to non-contrastive unsupervised learning of physiological signals from video.

### DISCUSSION OF THE RELATED ART

In general, biometrics may be used to track vital signs that provide indicators about a subject's physical state that may be used in a variety of ways. As an example, for border security or health monitoring, vital signs may be used to screen for health risks (e.g., temperature) or detect deception (e.g., change in pulse or pupil diameter). While sensing temperature is a well-developed technology, collecting other useful and accurate vital signs such as pulse rate (i.e., heart rate or heart beats per minute) or pulse waveform has required physical devices to be attached to the subject. The desire to perform biometric measurement without physical contact has produced some video-based techniques.

Performing reliable pulse rate or pulse waveform estimation from a camera sensor is more difficult than contact plethysmography for several reasons. The change in reflected light from the skin's surface, because of light absorption of blood, is very minor compared to those caused by changes in illumination. Even in settings with ambient lighting, the subject's movements drastically change the reflected light and overpower the pulse signal.

Camera-based vitals estimation is a rapidly growing field enabling non-contact health monitoring in a variety of settings. While the number of successful approaches has rapidly increased, the size of benchmark video datasets with simultaneous vitals recordings has remained relatively stagnant. It is well-known across the machine learning community that increasing the quantity and diversity of training data is an effective strategy for improving performance.

Collecting remote physiological data is challenging for several reasons. First, recording many hours of high-quality videos results in an unwieldy volume of data. Second, recording a diverse population of subjects with associated medical data is difficult due to privacy concerns. Furthermore, synchronizing contact measurements with video recordings in diverse settings is highly dependent on the researcher's hardware infrastructure and lab setting. Even contact measurements used for ground truth contain noise, making data curation difficult. These difficulties contributing to data scarcity stifle model scaling and robustness.

There are few publicly available sources of simultaneous video and physiological recordings, making it difficult to scrape data for supervised training. Fortunately, recent works have shown that unsupervised training for remote photoplethysmography (rPPG) is effective.

The primary class of approaches for remote pulse estimation have shifted over the last decade from blind source separation, through linear color transformations to training supervised deep learning-based models. While the color transformations generalize well across many datasets, deep learning-based models give better accuracy when tested on data from a similar distribution to the training set. To this end, deep learning research has focused on optimizing neural architectures for extracting robust spatial and temporal features from the limited benchmark datasets.

To get around the data bottleneck, large synthetic physiological datasets have recently become more popular. The SCAMPS dataset contains videos for 2,800 synthetic avatars in various environments with a range of corresponding labels including PPG, EKG, respiration, and facial action units. The UCLA-synthetic dataset contains 480 videos, and they show that training models with real and synthetic data gives the best results. Another strength of synthetic datasets is their ability to cover the broad range of skin tones, which may be difficult when collecting real data.

Another potential solution to the lack of physiological training data is unsupervised learning, where a large set of videos and periodic priors on the output signal is sufficient.

Self-supervised learning is progressing quickly for image representation learning. Recently, two main classes of approaches have been competing: contrastive and noncontrastive (or regularized) learning. Contrastive approaches define criteria for distinguishing whether two samples are the same or different, then compare the embeddings to pull or push apart the predictions. Noncontrastive methods augment positive pairs, and enforce variance in the predictions over batches to avoid the collapse, in which the model's embeddings reside in a tiny subspace of the feature space, instead of spanning a larger or entire embedding space. Distillation methods only use positive samples and avoid collapse by applying a moving average operation and stop-gradient operator. Another class of approaches maximize the information content of the embeddings.

All existing unsupervised rPPG approaches are contrastive. In the contrastive framework, pairs of input videos are passed as input to the same model, and the predictions over similar videos are pulled closer, while the predictions from dissimilar videos are repelled. The method for selecting negative samples differs across the previous literature, but the underlying contrastive framework is similar.

Accordingly, the inventors have developed systems, devices, methods, and non-transitory computer-readable instructions that enable non-contrastive unsupervised learning of physiological signals from video.

### SUMMARY OF THE INVENTION

Accordingly, the present invention is directed to non-contrastive unsupervised learning of physiological signals from video that substantially obviates one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the embodiments include Systems, devices, methods, and non-transitory computer-readable instructions for non-contrastive unsupervised learning of a physiological signal from a video stream, the computer-implemented method including capturing the video stream of a subject, the video stream including a sequence of frames; processing each frame of the video stream to update a physiological signal detection function; determining the physiological signal from the video stream, and applying the updated physiological signal detection function to a subsequent video steam.

In connection with any of the various embodiments, the media or video stream includes one or more of a visible-light video stream, a near-infrared video stream, a longwave-infrared video stream, a thermal video stream, and an audio stream of the subject.

In connection with any of the various embodiments, the physiological signal includes at least one of pulse rate, blood pressure, or eye blink rate.

In connection with any of the various embodiments, the physiological signal includes at least one of pulse rate or voice frequency.

In connection with any of the various embodiments, cropping each frame of the media stream to encapsulate a region of interest that includes one or more of a face, cheek, forehead, or an eye.

In connection with any of the various embodiments, the region of interest includes two or more body parts.

In connection with any of the various embodiments, combining at least two of a visible-light video stream, a near-infrared video stream, and a thermal video stream into a fused video stream.

In connection with any of the various embodiments, the visible-light video stream, the near-infrared video stream, and/or the thermal video stream are combined according to a synchronization device.

It is to be understood that both the foregoing general description and the following detailed description are examples and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a system for pulse waveform estimation.

FIG. 2 is an overview of the non-contrastive unsupervised learning (NCUL) framework for remote photoplethysmography (rPPG) compared with traditional supervised and unsupervised learning.

FIG. 3 illustrates the result of training exclusively with the bandwidth loss L_{b}.

FIG. 4 illustrates the results for models trained and tested on subject-disjoint partitions from the same datasets.

FIG. 5 illustrates within-dataset waveform predictions on baseline datasets from end-to-end unsupervised models over an 8-second window.

FIG. 6 illustrates the results for NCUL and supervised training on the same architecture.

FIG. 7 illustrates the results for training and testing on UBFC-rPPG.

FIG. 8 illustrates a computer-implemented method for non-contrastive unsupervised learning of a physiological signal from a video stream.

### DETAILED DESCRIPTION OF THE EXEMPLARY EMBODIMENTS

Reference will now be made in detail to the embodiments of the present invention, examples of which are illustrated in the accompanying drawings. Wherever possible, like reference numbers will be used for like elements.

Embodiments of user interfaces and associated methods for using a device are described. It should be understood, however, that the user interfaces and associated methods can be applied to numerous devices types, such as a portable communication device such as a tablet or mobile phone. The portable communication device can support a variety of applications, such as wired or wireless communications. The various applications that can be stored (in a non-transitory memory) and executed (by a processor) on the device can use at least one common physical user-interface device, such as a touchscreen. One or more functions of the touchscreen as well as corresponding information displayed on the device can be adjusted and/or varied from one application to another and/or within a respective application. In this way, a common physical architecture of the device can support a variety of applications with user interfaces that are intuitive and transparent.

The embodiments of the present invention provide systems, devices, methods, and non-transitory computer-readable instructions to measure one or more biometrics, including heart-rate, pulse waveform, and/or respiration without physical contact with the subject. Other biometrics can include pulse, gaze, blinking, pupillometry, face temperature, oxygen level, blood pressure, audio, voice tone and/or frequency, micro-expressions, etc.). In the various embodiments, the systems, devices, methods, and instructions collect, process, and analyze video taken in one or more modalities (e.g., visible light, near infrared, longwave infrared, thermal) to provide non-contrastive unsupervised learning of physiological signals from a video signal or video data (e.g., MP4).

Additional biometric sensors can be used to expand the potential to address challenges in remote human monitoring. In various embodiments, changes to the subject's eye gaze, eye blink rate, pupil diameter, speech, face temperature, and micro-expressions are also can be used.

As describe herein, the pulse or pulse waveform for the subject's heartbeat may be used as a biometric input to establish features of the physical state of the subject and how they change over a period of observation (e.g., during questioning or other activity). Remote photoplethysmography (rPPG) is the monitoring of blood volume pulse from a camera at a distance. Using rPPG, blood volume pulse from video at a distance from the skin's surface may be detected. The disclosure of U.S. application Ser. No. 17/591,929, entitled “VIDEO BASED DETECTION OF PULSE WAVEFORM”, filed 3 Feb. 2022, is hereby incorporated by reference, in its entirety.

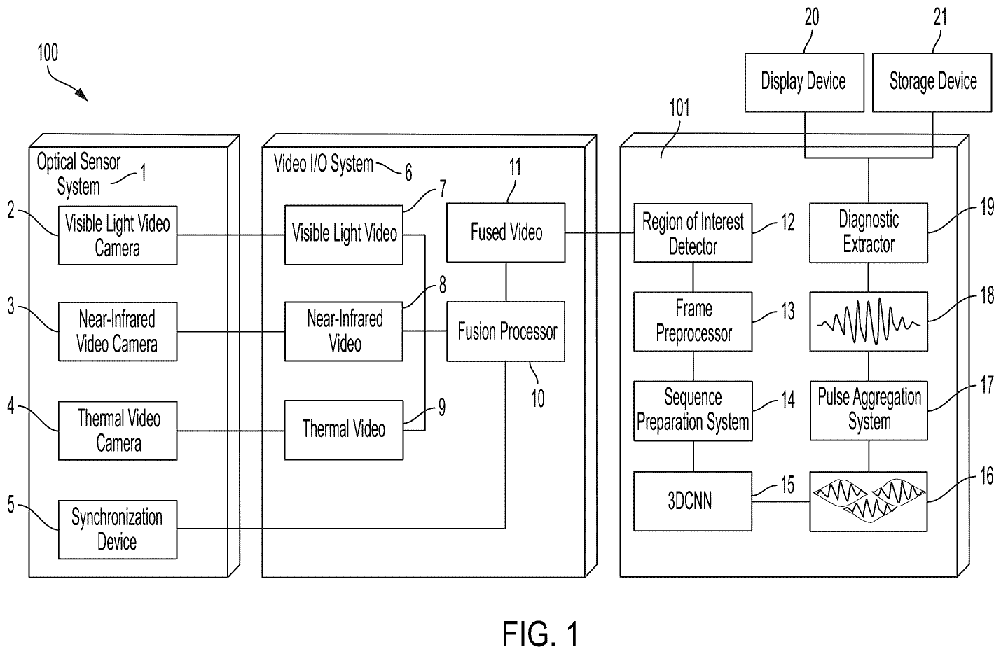

FIG. 1 illustrates a system 100 for pulse waveform estimation. System 100 includes optical sensor system 1, video I/O system 6, and video processing system 101.

Optical sensor system 1 includes one or more camera sensors, each respective camera sensor configured to capture a video stream including a sequence of frames. For example, optical sensor system 1 may include a visible-light camera 2, a near-infrared camera 3, a thermal camera 4, or any combination thereof. In the event that multiple camera sensors are utilized (e.g., single modality or multiple modality), the resulting multiple video streams may be synchronized according to synchronization device 5. Alternatively, or additionally, one or more video analysis techniques may be utilized to synchronize the video streams. Although a visible-light camera 2, a near-infrared camera 3, a thermal camera 4 are enumerated, other media devices can be used, such as a speech recorder.

Video I/O system 6 receives the captured one or more video streams. For example, video I/O system 6 is configured to receive raw visible-light video stream 7, near-infrared video stream 8, and thermal video stream 9 from optical sensor system 1. Here, the received video streams may be stored according to known digital format(s). In the event that multiple video streams are received (e.g., single modality or multiple modality), fusion processor 10 is configured to combine the received video streams. For example, fusion processor 10 may combine visible-light video stream 7, near-infrared video stream 8, and/or thermal video stream 9 into a fused video stream 11. Here, the respective streams may be synchronized according to the output (e.g., a clock signal) from synchronization device 5.

At video processing system 101, region of interest detector 12 detects (i.e., spatially locate) one or more spatial regions of interest (ROI) within each video frame. The ROI may be a face, another body part (e.g., a hand, an arm, a foot, a neck, etc.) or any combination of body parts. Initially, region of interest detector 12 determines one or more coarse spatial ROIs within each video frame. Region of interest detector 12 is robust to strong facial occlusions from face masks and other head garments. Subsequently, frame preprocessor 13 crops the frame to encapsulate the one or more ROI. In some embodiments, the cropping includes each frame being downsized by bi-cubic interpolation to reduce the number of image pixels to be processed. Alternatively, or additionally, the cropped frame may be further resized to a smaller image.

Sequence preparation system 14 aggregates batches of ordered sequences or subsequences of frames from frame processer 13 to be processed. Next, 3-Dimensional Convolutional Neural Network (3DCNN) 15 receives the sequence or subsequence of frames from the sequence preparation system 14. 3DCNN 15 processes the sequence or subsequence of frames, by a 3-dimensional convolutional neural network, to determine the spatial and temporal dimensions of each frame of the sequence or subsequence of frames and to produce a pulse waveform point for each frame of the sequence of frames. 3DCNN 15 applies a series of 3-dimensional convolution, averaging, pooling, and nonlinearities to produce a 1-dimensional signal approximating the pulse waveform 16 for the input sequence or subsequences.

In some configurations, pulse aggregation system 17 combines any number of pulse waveforms 16 from the sequences or subsequences of frames into an aggregated pulse waveform 18 to represent the entire video stream. Diagnostic extractor 19 is configured to compute the heart rate and the heart rate variability from the aggregated pulse waveform 18. To identify heart rate variability, the calculated heart rate of various subsequences may be compared. Display unit 20 receives real-time or near real-time updates from diagnostic extractor 19 and displays aggregated pulse waveform 18, heart rate, and heart rate variability to an operator. Storage Unit 21 is configured to store aggregated pulse waveform 18, heart rate, and heart rate variability associated with the subject.

Additionally, or alternatively, the sequence of frames may be partitioned into a partially overlapping subsequences within the sequence preparation system 14, wherein a first subsequence of frames overlaps with a second subsequence of frames. The overlap in frames between subsequences prevents edge effects. Here, pulse aggregation system 17 may apply a Hann function to each subsequence, and the overlapping subsequences added to generate aggregated pulse waveform 18 with the same number of samples as frames in the original video stream. In some configurations, each subsequence is individually passed to the 3DCNN 15, which performs a series of operations to produce a pulse waveform for each subsequence 16. Each pulse waveform output from the 3DCNN 15 is a time series with a real value for each video frame. Since each subsequence is processed by the 3DCNN 15 individually, they are subsequently recombined.

In some embodiments, one or more filters may be applied to the region of interest. For example, one or more wavelengths of LED light may be filtered out. The LED may be shone across the entire region of interest and surrounding surfaces or portions thereof. Additionally, or alternatively, temporal signals in non-skin regions may be further processed. For example, analyzing the eyebrows or the eye's sclera may identify changes strongly correlated with motion, but not necessarily correlated with the photplethysmogram. If the same periodic signal predicted as the pulse is found on non-skin surfaces, it may indicate a non-real subject or attempted security breach.

Although illustrated as a single system, the functionality of system 100 may be implemented as a distributed system. While system 100 determines heart rate, other distributed configurations track changes to the subject's eye gaze, eye blink rate, pupil diameter, speech, face temperature, and micro-expressions, for example. Further, the functionality disclosed herein may be implemented on separate servers or devices that may be coupled together over a network, such as a security kiosk coupled to a backend server. Further, one or more components of system 100 may not be included. For example, system 100 may be a smartphone or tablet device that includes a processor, memory, and a display, but may not include one or more of the other components shown in FIG. 1. The embodiments may be implemented using a variety of processing and memory storage devices. For example, a CPU and/or GPU may be used in the processing system to decrease the runtime and calculate the pulse in near real-time. System 100 may be part of a larger system. Therefore, system 100 may include one or more additional functional modules.

Subtle quasi-periodic physiological signals such as blood volume pulse and respiration can be extracted from RGB video, enabling remote health monitoring and other applications. Advancements in remote pulse estimation—or remote photoplethysmography (rPPG)—are currently driven by supervised deep learning solutions. However, current approaches are trained and evaluated on limited benchmark datasets recorded with ground truth from contact-PPG sensors.

The embodiments provide the first non-contrastive unsupervised learning framework for signal regression to reduce and/or eliminate the constraints of labelled video data. With minimal assumptions of periodicity and finite bandwidth, the embodiments identify a blood volume pulse directly from unlabelled videos. Encouraging sparse power spectra within the desired bandlimits and variance over a batch of power spectra is sufficient for learning visual features of periodic signals. Utilizing unlabelled video data not specifically created for rPPG to train robust pulse rate estimators was validated. Given the limited inductive biases and positive empirical results, the embodiments can be readily applied to other periodic signals from video, enabling multiple physiological measurements without the need for ground truth.

The embodiments provide non-contrastive unsupervised learning of physiological signals from video. A model can be guided towards extracting periodic signals from video using a non-contrastive formulation. When given face videos and instructed to identify a periodic signal between 40 and 180 beats per minute, the model correctly learns to estimate the blood volume pulse, despite the subtlety of the visual face features delivering information about the blood pulse.

The embodiments provide a framework for non-contrastive unsupervised learning by leveraging periodic signal priors. The embodiments also provide the first non-contrastive unsupervised learning method for camera-based vitals measurement. Moreover, the embodiments enable training models with a non-rPPG-specific video dataset without ground truth vitals.

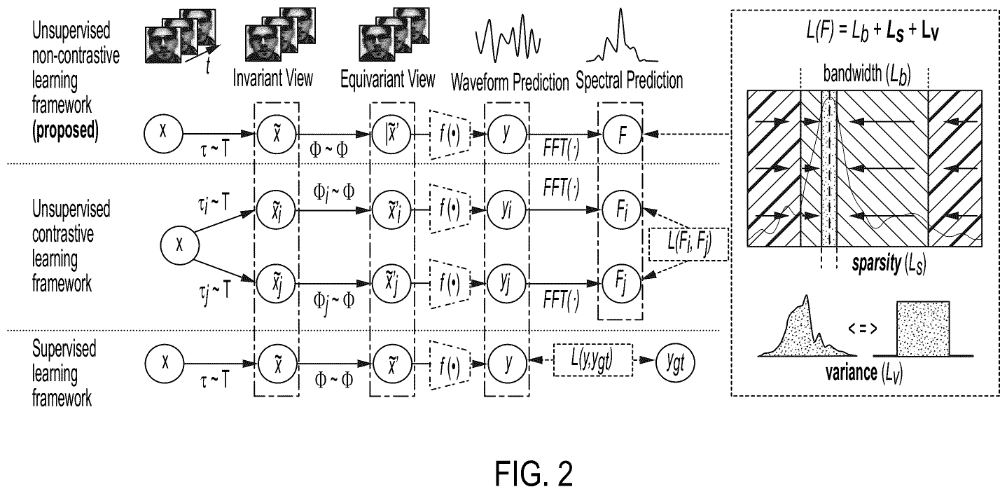

FIG. 2 is an overview of the non-contrastive unsupervised learning (NCUL) framework for remote photoplethysmography (rPPG) compared with traditional supervised and unsupervised learning. Supervised and contrastive losses use distance metrics to the ground truth or other samples. The framework applies the loss directly to the prediction by shaping the frequency spectrum, and encouraging variance over a batch of inputs. Power outside of the bandlimits are penalized to learn invariances to irrelevant frequencies. Power within the bandlimits is encouraged to be sparsely distributed near the maximum frequency.

At the outset, the general setup for signal regression from video is formulated. A video sample xᵢ∈R^{T×W×H×C} sampled from a dataset D consists of T images of size W×H pixels across C channels, captured uniformly over time. State-of-the-art methods offer models f that regress a waveform R^{T} [symbol] yᵢ=f(xᵢ) of the same length as the video. Recently, the task has been effectively modeled end-to-end with the models f being spatiotemporal neural networks. While previous works are supervised and minimize the loss to a contact pulse measurement, here non-contrastive learning uses only the model's estimate.

Strong priors can be placed on the estimated pulse (e.g. frequency range and strong periodicity). Next, the one or more constraints can be implemented in the frequency domain rather than the time domain. Thus, waveform predictions are passed through the FFT prior to computing losses.

Losses. One of the advantages of unsupervised learning for periodic signals is that the solution space can be constrained significantly. For physiological signals such as respiration and blood volume pulse, the healthy upper and lower bounds of the frequencies in breaths and beats per minute are known. The extracted signal is relatively sparse in the frequency domain, and the model filters out noise signals present in the video. With these constraints, the problem of finding good features for the desired signal in the data is simplified.

One of the most useful constraints on the model is frequency bandlimits. Past unsupervised methods have used the irrelevant power ratio (IPR) as a validation metric for model selection. Use of frequency bandlimits is also effective during model training. With lower and upper bandlimits of a and b, respectively, the bandwidth loss becomes:

$${L}_{b} = \frac{\text{?} {F}_{i} + {\sum }_{i = b}^{∞} {F}_{i}}{{\sum }_{i = - ∞}^{∞} {F}_{i}} \qquad ( 1 )$$

$$\text{?} \text{indicates text missing or illegible when filed}$$

where Fᵢ is the spectral power of the predicted signal for frequency i, allowing to penalize the model for generating signals outside the desired bandlimits. This loss enforces learning of many invariants, such as movement from respiration, talking, or facial expressions which typically occupy low frequencies. For example, the limits as a=0.66 Hz to b=3 Hz may be used, which corresponds to a common pulse rate range from 40 bpm to 180 bpm.

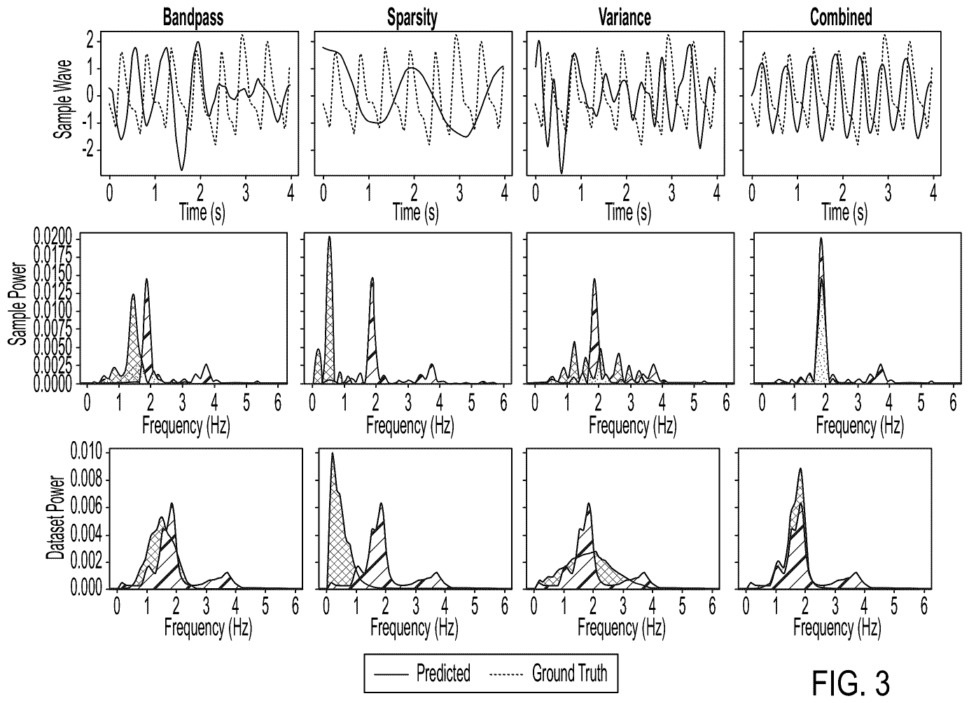

FIG. 3 illustrates the result of training exclusively with the bandwidth loss L_{b}. Each column shows predictions from models trained with one or each of the losses for 20 epochs on UBFC-rPPG. The first two rows illustrate a sample in the time and frequency domain, respectively. The last row illustrates the distribution of signal power over the entire validation set. The bandwidth loss penalizes signal power outside predefined bandlimits (e.g., 40 to 180 bpm) to constrain the output space. The last row also illustrates that the model limits the signal power between the bandlimits. The sparsity loss encourages a narrow spectrum containing a strong periodic component. By itself, the model learns the solution characterized by very low frequencies. The variance loss encourages diverse power spectra over a batch, preventing the model from collapsing to a narrow bandwidth. When combined, the model learns to estimate periodic signals within the desired bandlimits.

The blood volume pulse contains a dominant frequency, and it's most common physiological marker used in practice is the pulse rate. The model can be enhanced by penalizing wideband predictions. This also simplifies the true signal that the model should identify by penalizing visual dynamics that may not exude periodicity. A similar formulation to the IPR can be used, but the frequency bounds are selected near the maximum predicted frequency. Concretely, the sparsity loss, Lₛ, is the same as equation (1) if the bandlimits are substituted for −∞ and ∞, a=argmax(F)−ΔF, and b=argmax(F)+ΔF. Experiments were performed with a ΔF of 6 beats per minute. Here, FIG. 3 illustrates the result of training only with the sparsity loss in the second column. For a single sample, the power spectrum is very sparse. For the whole dataset, it is easier to predict sparse solutions when high frequencies are ignored entirely and visual features corresponding to low frequencies are learned.

One of the risks of non-contrastive methods is the model collapsing into trivial solutions and making predictions independently of the input features. In regularized methods such as VICReg, a hinge loss on the variance over a batch of predictions is used to enforce diverse outputs. A similar strategy can be used to avoid model collapse, but instead spread the variance in power spectral densities towards a uniform distribution over the supported frequencies.

The variance loss processes a uniform prior distribution P over d frequencies, and a batch of n spectral densities, F=[v1, . . . , vn], where each vector is a d-dimensional frequency decomposition of a predicted waveform. The normalized sum of densities over the batch, Q, is calculated. Also, define the variance loss as the squared Wasserstein distance to the uniform prior:

$$L \text{?} = \frac{1}{d} {\sum }_{i = 1}^{d} {( {CDF}_{1} ( Q ) - {CDF}_{1} ( P ) )}^{2} , \qquad ( 2 )$$

$$\text{?} \text{indicates text missing or illegible when filed}$$

where CDF is a cumulative distribution function. The variance loss benefits from large batch sizes, since small batches may occupy a small range of frequencies. The third column of FIG. 3 illustrates the effect of the variance loss during model training. For a single sample, wide-band signals containing multiple frequencies are predicted, and the frequencies over the predicted dataset cover the task's bandwidth.

Summarizing, the training loss function is a sum of the aforementioned losses:

L=L_{b}+Lₛ+L_{c}. (3)

While one could weight particular components of the loss more than others, the losses were formulated to scale between 0 and 1. Based on experimental use, it was found that the summation without weighting gives good performance. The combined loss function encourages the model to search over the supported frequencies to discover visual features for a strong periodic signal. Remarkably, the framework is sufficient for learning to regress the blood volume in video, as illustrated in the last column of FIG. 3.

Unlike known approaches, which only apply frequency augmentations, several augmentations are applied to both the spatial and temporal dimensions to enhance the model to identify invariances to noise it may encounter in real settings.

Image Intensity Augmentations. Random Gaussian noise is added to each pixel location in a clip with a mean of 0 and a standard deviation of 2 on the original image scale from 0 to 255. The illumination is augmented by adding a constant sampled from a Gaussian distribution with mean 0 and standard deviation of 10 to every pixel in a clip, which darkens or brightens the video.

Spatial Augmentations. A video clip is randomly flipped horizontally with 50% probability. The spatial dimension of a clip are randomly square cropped down to between half the original length and the original length. The cropped clip is then linearly interpolated back up to the original spatial dimensions.

Temporal Augmentations. With the general assumption that the desired signal is strongly periodic and sparsely represented in the Fourier domain, a video clip is randomly flipped along the time dimension with a probability of 50%. Note that the Fourier decomposition of a time-reversed sinusoid is identical to that of the original sinusoid.

Frequency Augmentations. Perhaps the most important augmentation is frequency resampling, where the video is linearly interpolated to a different frame rate. This augmentation is particularly interesting for rPPG, because it transforms the video input and target signal equivalently along the time dimension, making it equivariant. Given the aforementioned transformations that are invariant, τ(⋅)˜T, the equivariant frequency resampling operation, ϕ(⋅)ϕ, and a model f(⋅) that infers a waveform from a video having the following:

ϕ(f(τ(x)))=f(ϕ(τ(x))), (4)

This is a powerful augmentation, because it allows the augmentation of the target distribution along with the video input. In the experiments, input clips were randomly resampled by a factor c˜U(0.6, 1.4). After applying the resampling augmentation, the bandlimits were subsequently scale by c to avoid penalizing the model if the augmentation pushed the underlying pulse frequency outside of the original bandlimits.

Several experiments were performed to evaluate within-dataset and cross-dataset performance. PURE, UBFC-rPPG, and DDPM were used as benchmark rPPG datasets for both training and testing, and the CelebV-HQ dataset and HKBU-MARs for unsupervised training only.

Deception Detection and Physiological Monitoring (DDPM) consists of 86 subjects in an interview setting, where subjects attempted to respond to questions deceptively. Interviews were recorded at 90 frames per second for more than 10 minutes on average. Natural conversation and frequent head pose changes make it a difficult and less-constrained rPPG dataset.

PURE is a benchmark rPPG dataset consisting of 10 subjects recorded over 6 sessions. Each session lasted approximately 1 minute, and raw video was recorded at 30 fps. The 6 sessions for each subject consisted of: (1) steady, (2) talking, (3) slow head translation, (4) fast head translation, (5) small and (6) medium head rotations. Pulse rates are at or close to the subject's resting rate.

UBFC-rPPG contains 1-minute long videos from 42 subjects recorded at 30 fps. Subjects played a time-sensitive mathematical game to raise their heart rates, but head motion is limited during the recording.

HKBU 3D Mask Attack with Real World Variations (HKBU-MARs) consists of 12 subjects captured over 6 different lighting configurations with 7 different cameras each, resulting in 504 videos lasting 10 seconds each. The diverse lighting and camera sensors make it a valuable dataset for unsupervised training. Version 2 of HKBU-MARs was used, which contains videos with both realistic 3D masks and unmasked subjects.

High-Quality Celebrity Video Dataset (CelebVHQ) is a set of processed YouTube videos containing 35,666 face videos from over 15,000 identities. The videos vary dramatically in length, lighting conditions, emotion, motion, skin tones, and camera sensors. Given a sufficient method for unsupervised learning, the CelebV-HQ dataset seems a good candidate for training a robust model for pulse estimation. The greatest challenge in harnessing online videos is their reduced quality, which may be compressed both before upload and by the video provider. Compression is a known challenge for rPPG, since the blood volume pulse is so subtle optically.

Training, Data Preprocessing. To prepare the video clips for the spatiotemporal deep learning models, 68 face landmarks were extracted with OpenFace. a bounding box in each frame was defined with the minimum and maximum (x, y) locations by extending the crop horizontally by 5% to ensure that the cheeks and jaw are present. The top and bottom was extended by 30% and 5% of the bounding box height, respectively, to include the forehead and jaw. The shorter of the two axes were extended to the length of the other to form a square. The cropped frames were then resized to 64×64 pixels with bicubic interpolation. For faster processing of the massive CelebV-HQ dataset, MediaPipe Face Mesh was used for landmarking.

Model Architectures. A 3D-CNN can be used architecture. A temporal kernel width of 5 was used, and default zero-padding was replaced by repeating the edges. Zero-padding along the time dimension can result in edge effects that add artificial frequencies to the predictions. Experiments showed that internal temporal dilations caused aliasing and reduced the bandwidth of the model to specific frequencies. Losses and framework may be applied to any task and architecture with dense predictions along one or more dimensions. However, popular rPPG architectures such as DeepPhys and MTTS-CAN may be ill-suited for the approach, since they consume very few frames, and the number of time points should be large enough to give sufficient frequency resolution with the FFT.

Supervised Training. To properly compare the embodiments to its supervised counterpart, the same model architecture was used and trained with the negative Pearson loss between the predicted waveform and the contact sensor ground truth. During training, the same augmentations were applied except time reversal. Models are trained for 200 epochs on PURE and UBFC-rPPG, and for 40 epochs on DDPM. The model from the epoch with the lowest loss on the validation set is selected for testing.

Unsupervised Training. Unsupervised models are trained for the same number of epochs as the supervised setting for both PURE and UBFCrPPG, but trained for an additional 40 epochs on DDPM, since this dataset is considerably more difficult. Contrary to previous unsupervised approaches, validation sets were leveraged for model selection by selecting the model with the lowest combined bandpass and sparsity losses on unseen samples.

Evaluation. Pulse rates are computed as the highest spectral peak between 0.66 Hz and 3 Hz (equivalent to 40 bpm to 180 bpm) over a 10-second sliding window. The same procedure is applied to the ground truth waveforms for a reliable evaluation. Common error metrics are applied such as mean absolute error (MAE), root mean square error (RMSE), and Pearson correlation coefficient between the pulse rates. We perform 5-fold cross validation for both PURE and UBFC, and use the predefined dataset splits from DDPM. Three (3) models were with different initializations, resulting in 15 models trained on PURE and UBFC each, and 3 models trained on DDPM. The mean and standard deviation of the errors in the results are presented.

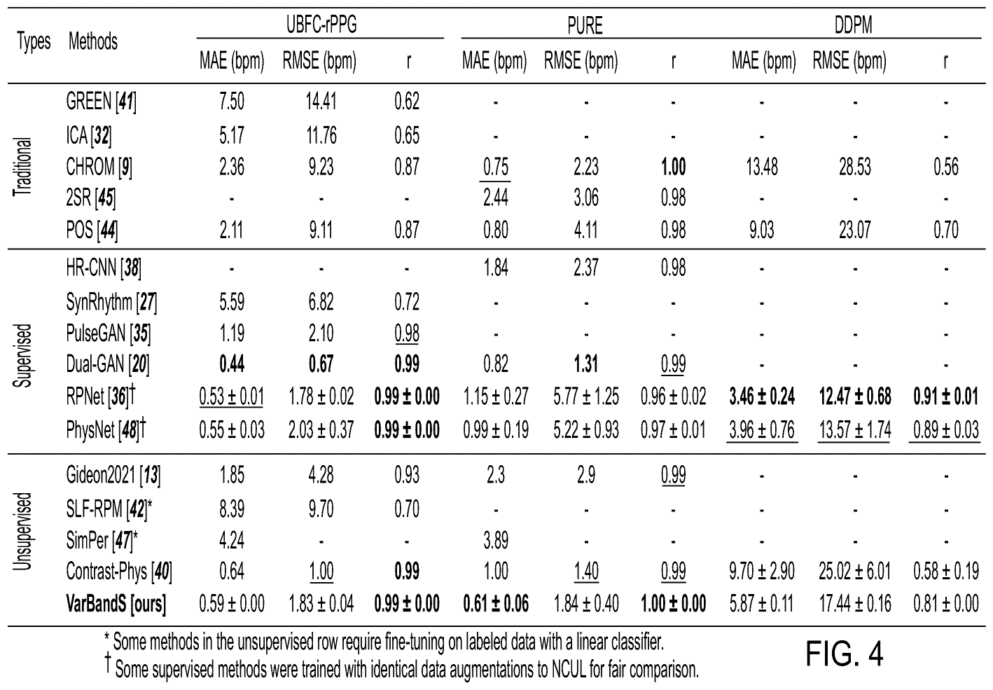

Results, Dataset Testing. FIG. 4 illustrates the results for models trained and tested on subject-disjoint partitions from the same datasets. For PURE and UBFC, a MAE lower than 1 bpm was achieved, performing better or on par with all traditional and supervised learning approaches. For PURE, the embodiments give the lowest MAE and a Pearson r of nearly 1. Performance drops on DDPM due to the overall difficulty of the dataset and segments of noise from movement of the fingertip oximeter. Nevertheless, the embodiments outperform existing unsupervised approaches and traditional methods, only being surpassed by the supervised deep learning approaches.

In comparison to other unsupervised methods, Contrast-Phys gives the most competitive performance on all but DDPM. Note that the embodiments give the lowest MAE on all datasets, but has higher RMSE. This is likely due their use of harmonic removal as a post-processing step when estimating the pulse rate, which is not described in, but can be found in their publicly available code.

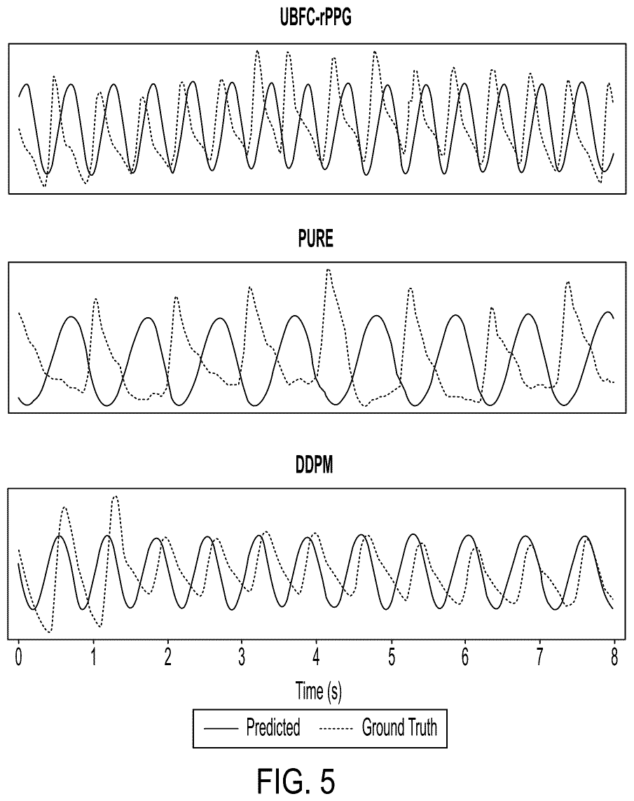

FIG. 5 illustrates within-dataset waveform predictions on baseline datasets from end-to-end unsupervised models over an 8-second window. The model predictions are remarkably periodic without any form of filtering. Note that phase is not considered during training, so each model learns its own phase.

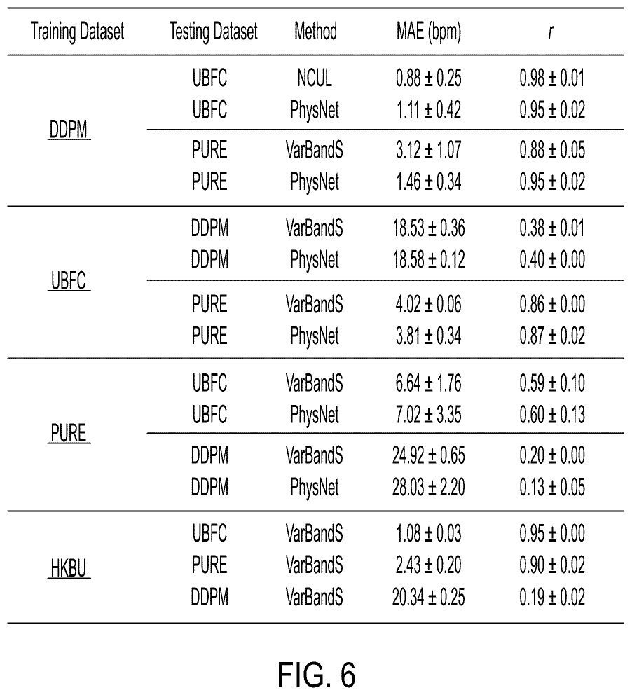

Cross-Dataset Testing. In addition to traditional within-dataset experiments, cross-dataset testing was performed to analyze whether the approach is robust to changes to the lighting, camera sensor, pulse rate distribution, and motion. FIG. 6 illustrates the results for NCUL and supervised training on the same architecture. In general, it was found that the performance is similar for the supervised and unsupervised approaches when transferring to different data sources. Training on PURE exclusively gives relatively poor results when transferring to UBFC-rPPG and DDPM, due to the low pulse rate variability and lack of movement. Training on DDPM gives the best results overall, since the dataset is the largest and captures larger subjects' movements compared to other datasets.

Training with CelebV-HQ Videos Given the abundance of face videos publicly available online, a model was trained on faces from the CelebV-HQ dataset. After processing the available videos for download with Mediapipe, and resampling video clips to 30 fps, the unlabeled dataset consisted of 34,029 videos. The model trained for 23 epochs and was manually stopped training due to a plateau in the validation loss. Unfortunately, it was found that the model could not converge to the true blood volume pulse. The failure is likely due to poor data quality from compression. Although the videos were downloaded with the highest available quality, the videos have likely been compressed multiple times, effectively removing the pulse signal entirely. The MAE in bpm for UBFC-rPPG, PURE, and DDPM was 19.22, 24.83, and 27.41, respectively.

Training with HKBU-MARs Videos. The HKBU-MARs dataset was designed for face presentation attack detection, but the models were trained on the “real” video sessions in the dataset. The bottom rows in FIG. 6 illustrate the results for training exclusively on HKBUMARs, then testing on the benchmark rPPG datasets. Training on HKBU-MARs gives better results when transferring to UBFC-rPPG and PURE than all training sets except DDPM, which is an order of magnitude larger and contains motion artifacts. This is the first known to us and successful experiment showing that non-rPPG videos can be used to train robust models even if they do not have ground-truth pulse labels.

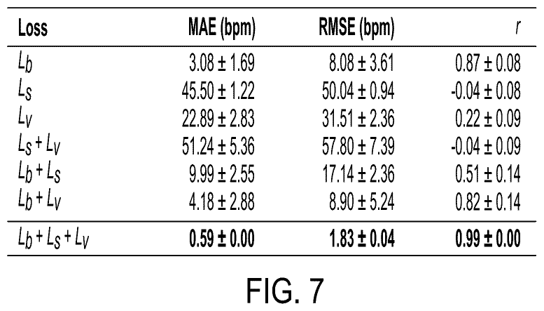

Ablation Study on Losses. Models were trained using all combinations of loss components to analyze their contributions. FIG. 7 illustrates the results for training and testing on UBFC-rPPG. The bandpass loss is critical for discovering the true blood volume pulse, while the sparsity and variance losses do not learn the desired signal by themselves. Surprisingly, combining the bandpass loss with just one of the sparsity or variance losses gives worse performance than just the bandpass loss. However, when combining all three components, the model achieves improved results.

Discussion. It is initially surprising that unsupervised training leads to similar or improved rPPG estimation models compared to those trained in supervised manner. However, there are several potential benefits to unsupervised training. From a hardware perspective, one of the difficulties in supervised training is aligning the contact pulse waveform with the video frames. The pulse sensor and camera may have a time lag, effectively giving the model an out-of-phase target at training time. A benefit of unsupervised training is giving the model the freedom to learn the phase directly from the video.

The contact pulse signal may also be noisy, as PPG is very sensitive to motion. Since motion may occur at the face and fingertip simultaneously, noise from movement may appear in the target, misguiding the model to learn a visual feature for which they should be invariant.

From a physiological perspective, the pulse observed optically at the fingertip with a contact sensor has a different phase than that of the face, since blood propagates along a different path before reaching the peripheral microvasculature, making alignment nearly impossible without shifting the targets to rPPG estimates from existing methods.

Additionally, the morphological shape of the contact-PPG waveform depends on numerous factors such as the wavelength of light (and corresponding tissue penetration depth), external pressure from the oximeter clip, and vasodilation at the measurement site. These external factors indicate that the morphology and phase of the target PPG waveforms are likely different from the observed rPPG waveform. By training a model to predict the proxy targets, unnecessary artifacts were introduced and optimal features were not learned for accurate pulse measurement.

The success of the proposed non-contrastive approach depends on specific properties of the data, model, and how the two interact. Limited model capacity is actually a strength, since it forces discovering features to generalize across inputs. An infinite capacity network could discover spurious signals in the training data and fail to generalize. By constraining the model's predictions to have specific periodic properties the limited-capacity model must find a general set of features to produce a signal that exists in all of the training samples, which happens to be the blood volume pulse in the datasets.

As a beneficial side-effect, the model intrinsically learns to ignore common noise factors such as illumination, rigid motion, non-rigid motion (e.g., talking, smiling, etc.), and camera noise, since they may result in signals outside the predefined band limits or with uniform power spectra. Even if noise exhibits periodic tendencies within the band limits for some samples, those features would produce poor signals on other samples. Therefore, end-to-end unsupervised approaches are particularly well-suited for periodic problems.

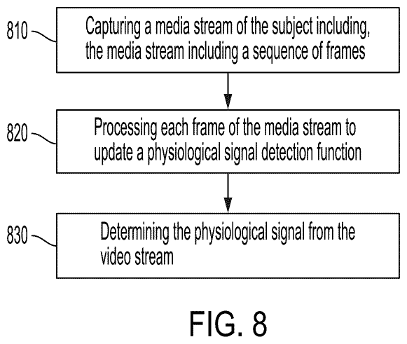

FIG. 8 illustrates a computer-implemented method for non-contrastive unsupervised learning of a physiological signal from a video stream.

At 810, the method captures a media stream (e.g., video or audio stream) of a subject including, the media stream including a sequence of frames. The video stream may include one or more of a visible-light video stream, a near-infrared video stream, and a thermal video stream of a subject. In some instances, the method can combine at least two of the visible-light video stream, the near-infrared video stream, and/or the thermal video stream into a fused video stream to be processed. The visible-light video stream, the near-infrared video stream, and/or the thermal video stream are combined according to a synchronization device and/or one or more video analysis techniques.

Next, at 820, the method processes each frame of the media stream to update a physiological signal detection function (e.g., update the function depicted as f(.) in FIG. 2, or weights thereof.).

At 830, the method determines the physiological signal from the media stream. For example, the physiological signal can include a plurality of biometrics including heart-rate, pulse waveform, and/or respiration. Other examples can include pulse, gaze, blinking, pupillometry, face temperature, oxygen level, blood pressure, audio, voice tone and/or frequency, micro-expressions, etc.). Although not shown, the updated physiological signal detection function can be readily applied to a subsequent video steam.

Aside from general performance improvements over, NCUL is also end-to-end unsupervised, so it does not require subsequent fine-tuning from the learned representations, and can instead infer the waveforms directly. The augmentations are also much simpler to implement, and require less processing during training.

Accordingly, the embodiments introduce a novel non-contrastive learning approach for end-to-end unsupervised signal regression, with specific experiments on blood volume pulse estimation from face videos. It has been shown that a simple loss formulation requiring loose frequency constraints is effective for learning powerful visual features.

It will be apparent to those skilled in the art that various modifications and variations can be made in the non-contrastive unsupervised learning of physiological signals from video of the present invention without departing from the spirit or scope of the invention. Thus, it is intended that the present invention cover the modifications and variations of this invention provided they come within the scope of the appended claims and their equivalents.

What is claimed is:

1. A computer-implemented method for non-contrastive unsupervised learning of a physiological signal from a video stream, the computer-implemented method comprising:
capturing the video stream of a subject including, the video stream including a sequence of frames;
processing each frame of the video stream to update a physiological signal detection function;
determining the physiological signal of the subject from the video stream; and
applying the updated physiological signal detection function to a subsequent video steam.

2. The computer-implemented method according to claim 1, wherein the video stream includes one or more of a visible-light video stream, a near-infrared video stream, a longwave-infrared video stream, a thermal video stream, and an audio stream of the subject.

3. The computer-implemented method according to claim 1, the physiological signal includes at least one of pulse rate, blood pressure, or eye blink rate.

4. The computer-implemented method according to claim 1, the physiological signal includes at least one of pulse rate or voice frequency.

5. The computer-implemented method according to claim 1, further comprising cropping each frame of the media stream to encapsulate a region of interest that includes one or more of a face, cheek, forehead, or an eye.

6. The computer-implemented method according to claim 5, wherein the region of interest includes two or more body parts.

7. The computer-implemented method according to claim 1, further comprising:
combining at least two of a visible-light video stream, a near-infrared video stream, and a thermal video stream into a fused video stream.

8. The computer-implemented method according to claim 7, wherein the visible-light video stream, the near-infrared video stream, and/or the thermal video stream are combined according to a synchronization device.

9. A system for non-contrastive unsupervised learning of a physiological signal from a video stream, the system comprising:
a processor; and
a memory storing one or more programs for execution by the processor, the one or more programs including instructions for:
capturing the video stream of a subject including, the video stream including a sequence of frames;
processing each frame of the video stream to update a physiological signal detection function;
determining the physiological signal of the subject from the video stream; and
applying the updated physiological signal detection function to a subsequent video steam.

10. The system according to claim 9, wherein the media stream includes one or more of a visible-light video stream, a near-infrared video stream, a longwave-infrared video stream, a thermal video stream, and an audio stream of the subject.

11. The system according to claim 9, the physiological signal includes at least one of pulse rate, blood pressure, or eye blink rate.

12. The system according to claim 9, wherein the physiological signal includes at least one of pulse rate or voice frequency.

13. The system according to claim 9, further comprising cropping each frame of the media stream to encapsulate a region of interest that includes one or more of a face, cheek, forehead, or an eye.

14. The system according to claim 13, wherein the region of interest includes two or more body parts.

15. The system according to claim 9, further comprising:
combining at least two of a visible-light video stream, a near-infrared video stream, and a thermal video stream into a fused video stream.

16. The system according to claim 15, wherein the visible-light video stream, the near-infrared video stream, and/or the thermal video stream are combined according to a synchronization device.
